(19) United States
(12) Patent Application Publication
(10) Pub. No.: US 2026/0061878 A1
(43) Pub. Date: Mar. 5, 2026

(54) BUILDING-SIDE PANEL AND SYSTEM

(71) Applicant: Panasonic Intellectual Property Management Co., Ltd., Osaka (JP)

(72) Inventor: Hiroki NISHIKAWA, Mie (JP)

(21) Appl. No.: 19/208,204

(22) Filed: May 14, 2025

(30) Foreign Application Priority Data
Aug. 28, 2024 (JP) 2024-146800

(51) Int. Cl. B60L 53/63; H02J 3/14

(52) U.S. Cl. CPC B60L 53/63; H02J 3/14

(57) ABSTRACT

A building-side panel is provided on an exterior of a building and is to be connected to a charging device that charges an electric vehicle. The building-side panel includes: a power outage detector that detects a power outage based on a voltage supplied from a commercial power supply; a main breaker connected to the commercial power supply via the power outage detector; and a switch provided between the power outage detector and the charging device. The switch is opened when the power outage is detected.

### CROSS REFERENCE TO RELATED APPLICATION

The present application is based on and claims priority of Japanese Patent Application No. 2024-146800 filed on Aug. 28, 2024. The entire disclosure of the above-identified application, including the specification, drawings and claims is incorporated herein by reference in its entirety.

### FIELD

The present disclosure relates to a building-side panel and a system.

### BACKGROUND

A system in which power is supplied from an electric vehicle in the event of a power shortage in a house has been known for some time (see Patent Literature (PTL) 1). This system uses an electric vehicle, an AC/DC converter that supplies power from a commercial power supply, and a bidirectional power supply device (a building-side panel) that charges the electric vehicle and supplies power to the house.

### CITATION LIST

### Patent Literature

PTL 1: Japanese Unexamined Patent Application Publication No. 2015-84643

### SUMMARY

### Technical Problem

Incidentally, in the stated system, when the electric vehicle supplies power to the house, reverse power flow to the commercial power supply may occur through the bidirectional power supply device and the AC/DC converter.

Accordingly, the present disclosure provides a building-side panel and a system in which reverse power flow does not easily occur.

### Solution to Problem

A building-side panel according to one aspect of the present disclosure is a building-side panel provided on an exterior of a building and to be connected to a charging device that charges an electric vehicle The building-side panel includes: a power outage detector that detects a power outage based on a voltage supplied by a commercial power supply; a main breaker connected to the commercial power supply via the power outage detector; and a switch provided between the power outage detector and the charging device. The switch is opened when the power outage is detected.

Additionally, a system according to one aspect of the present disclosure is a system including the above-described building-side panel and the charging device.

### Advantageous Effects

According to the present disclosure, a building-side panel and a system in which reverse power flow does not easily occur are realized.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a schematic diagram illustrating a house in which a system according to an embodiment is applied.

FIG. 2 is a block diagram illustrating the configuration of the system according to the embodiment.

FIG. 3A is a sequence chart illustrating Operation Example 1 of the system according to the embodiment.

FIG. 3B is a sequence chart illustrating Operation Example 1 of the system according to the embodiment.

FIG. 4 is a sequence chart illustrating Operation Example 2 of the system according to the embodiment.

FIG. 5A is a sequence chart illustrating Operation Example 3 of the system according to the embodiment.

FIG. 5B is a sequence chart illustrating Operation Example 3 of the system according to the embodiment.

FIG. 6A is a sequence chart illustrating Operation Example 4 of the system according to the embodiment.

FIG. 6B is a sequence chart illustrating Operation Example 4 of the system according to the embodiment.

### DESCRIPTION OF EMBODIMENTS

An embodiment will be described in detail hereinafter with reference to the drawings. The following embodiment will describe general or specific examples. The numerical values, shapes, materials, constituent elements, arrangements and connection states of constituent elements, steps, orders of steps, and the like in the following embodiment are merely examples, and are not intended to limit the present disclosure. Additionally, of the constituent elements in the following embodiment, constituent elements not denoted in the independent claims will be described as optional constituent elements.

Note also that the drawings are schematic diagrams, and are not necessarily exact illustrations. Configurations that are substantially the same are given the same reference signs in the drawings, and redundant descriptions may be omitted or simplified.

### Embodiment 1

### Configuration

System 1 according to the present embodiment will be described first.

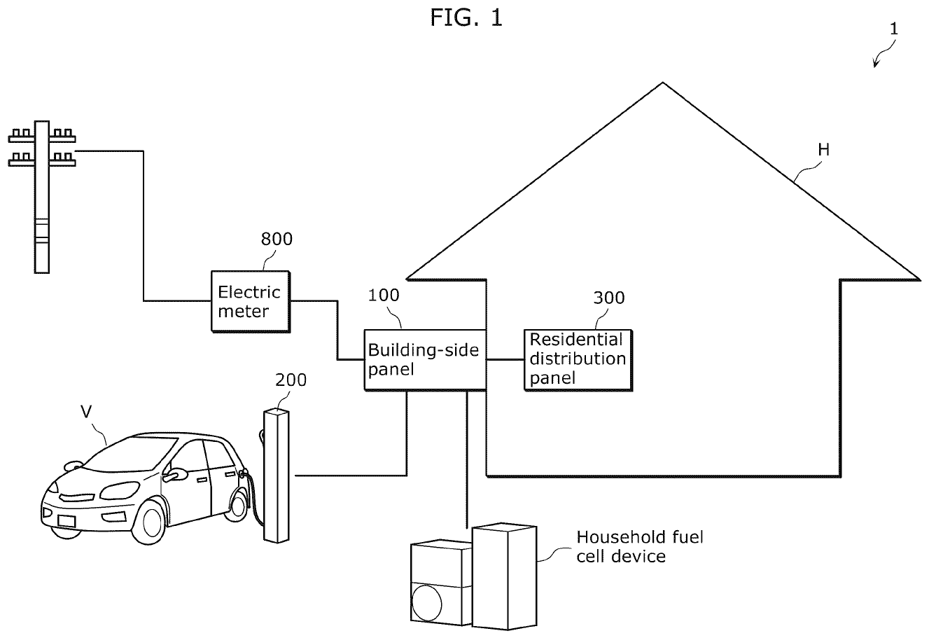

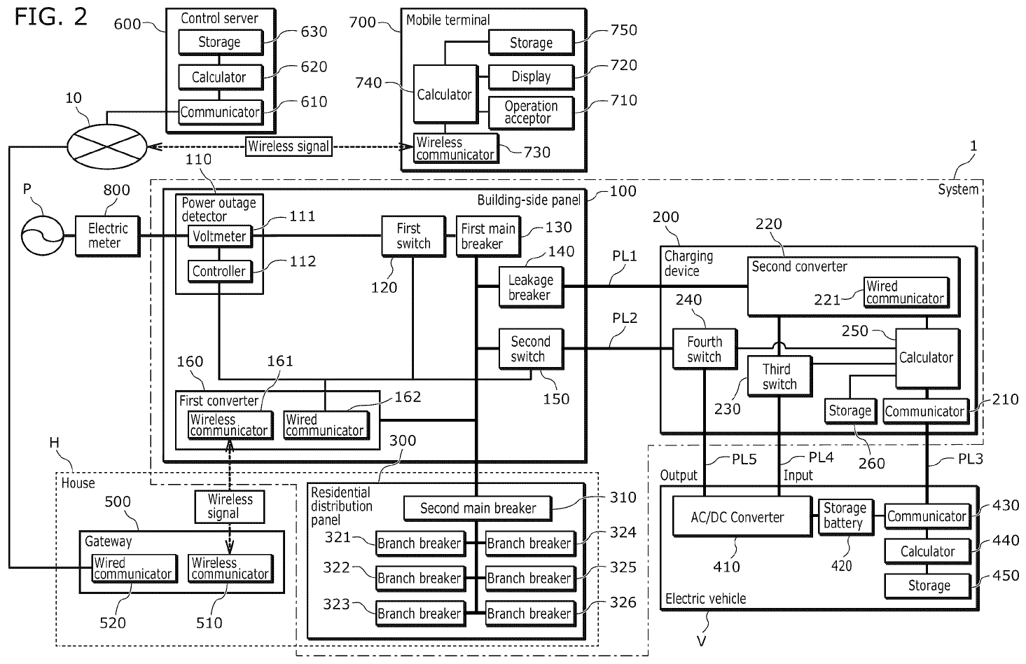

FIG. 1 is a schematic diagram illustrating house H in which system 1 according to the present embodiment is applied. FIG. 2 is a block diagram illustrating the configuration of system 1 according to the present embodiment.

System 1 is a system used in a building such as a single-family house or a housing complex. Here, system 1 is used in house H, which is an example of a single-family house.

System 1 is a system used to charge electric vehicle V. System 1 is a system for supplying power from electric vehicle V to house H in the event of a power outage in commercial power supply P that supplies power to house H, and is therefore a system used for Vehicle to Home (V2H). In other words, system 1 is an example of a power supply system.

System 1 and the constituent elements thereof will be described hereinafter.

An overview of system 1 will be given first. System 1 is a system including building-side panel 100, charging device 200, and residential distribution panel 300.

Building-side panel 100 is a device that is connected to and supplied with power from commercial power supply P, and that supplies power to both charging device 200 and residential distribution panel 300. Charging device 200 is a device that charges electric vehicle V. During power outages, charging device 200 supplies power from electric vehicle V to residential distribution panel 300. Residential distribution panel 300 obtains the power supplied from commercial power supply P or charging device 200, and distributes power to a plurality of loads provided in house H.

Building-side panel 100 and charging device 200 are connected by power line PL1, and first power line communication, which is power line communication over power line PL1, is used between building-side panel 100 and charging device 200. Note that power line PL1 is a power line used to charge electric vehicle V, i.e., is a power line used to supply power from building-side panel 100 to charging device 200. Accordingly, power line PL1 supplies a high voltage, specifically a voltage of at least 100 V, e.g., 100 V or 200 V.

Power lines are indicated by bold lines in FIG. 2.

Using the first power line communication, charging device 200 outputs, to building-side panel 100, a connection notification signal indicating, for example, that electric vehicle V and charging device 200 are connected.

Building-side panel 100, charging device 200, and residential distribution panel 300 will be described in detail next.

Building-side panel 100 is connected to commercial power supply P via electric meter 800. Building-side panel 100 is also connected to charging device 200 and a household fuel cell device. Building-side panel 100 is provided outside house H, and specifically, is provided on the exterior of house H.

Building-side panel 100 includes power outage detector 110, first switch 120, first main breaker 130, leakage breaker 140, second switch 150, and first converter 160.

Power outage detector 110 is a device that detects power outages based on a voltage supplied from commercial power supply P. In the present embodiment, “power outage” means, for example, a state in which the supply of power from commercial power supply P to building-side panel 100 has been interrupted or can be interrupted. Power outage detector 110 includes voltmeter 111 and controller 112.

Voltmeter 111 is a device that measures the voltage supplied from commercial power supply P. Voltmeter 111 outputs a value of the voltage measured (a voltage value) to controller 112.

Controller 112 obtains the voltage value output from voltmeter 111, and detects a power outage based on the voltage value obtained. In other words, controller 112 determines whether a power outage has occurred in commercial power supply P. As one example, controller 112 determines that a power outage has occurred in commercial power supply P when the voltage value obtained is less than a predetermined value (threshold). When a power outage is detected, controller 112 outputs a control signal to first switch 120, second switch 150, and first converter 160. Controller 112 controls first switch 120, second switch 150, and first converter 160 in this manner.

Additionally, after a power outage is detected, controller 112 obtains the voltage value output from voltmeter 111, and detects a recovery from the power outage based on the voltage value obtained. In other words, after a power outage has occurred in commercial power supply P, controller 112 determines whether commercial power supply P has recovered from the power outage. As one example, controller 112 determines that commercial power supply P has recovered from the power outage when the voltage value obtained is at least the predetermined value (threshold). When a recovery from a power outage is detected, controller 112 outputs a control signal to first switch 120, second switch 150, and first converter 160. Controller 112 controls first switch 120, second switch 150, and first converter 160 in this manner.

Controller 112 is implemented by a microcomputer, for example, but may be implemented by a processor.

First switch 120 is a switch provided between power outage detector 110 and charging device 200. More specifically, first switch 120 is provided between power outage detector 110 and first main breaker 130.

First switch 120 is a device that switches between opening and closing of a power line provided between power outage detector 110 and charging device 200, and more specifically, a power line provided between power outage detector 110 and first main breaker 130. In other words, first switch 120 closes or opens a circuit formed between power outage detector 110 and first main breaker 130.

First switch 120 obtains the control signal output from controller 112, and switches the opening and closing of the power line based on the control signal obtained.

First main breaker 130 is a breaker connected to commercial power supply P via power outage detector 110. More specifically, first main breaker 130 is connected to commercial power supply P via electric meter 800, power outage detector 110, and first switch 120. First main breaker 130 is a device for cutting off the voltage supplied from commercial power supply P. First main breaker 130 includes a switch, and the circuit is opened when the switch is operated by a user, for example.

Leakage breaker 140 is a device provided between first main breaker 130 and charging device 200. Leakage breaker 140 and charging device 200 are connected by power line PL1, which is used to supply power from building-side panel 100 to charging device 200. When leakage is detected, leakage breaker 140 cuts off the circuit from building-side panel 100 to charging device 200.

Second switch 150 is a device provided between first main breaker 130 and charging device 200. Second switch 150 and charging device 200 are connected by power line PL2, which is used to supply power from charging device 200 (electric vehicle V) to building-side panel 100. Second switch 150 is also a device provided between charging device 200 and residential distribution panel 300.

Second switch 150 is a device that switches between opening and closing of power line PL2 provided between power outage detector 110 and charging device 200, and more specifically, power line PL2 provided between (i) power outage detector 110 and (ii) fourth switch 240 provided in charging device 200. In other words, second switch 150 closes or opens a circuit formed between power outage detector 110 and fourth switch 240.

Second switch 150 obtains the control signal output from controller 112, and switches the opening and closing of the power line based on the control signal obtained.

First converter 160 includes wireless communicator 161 and wired communicator 162. First converter 160 is a communication module that receives a signal, converts the communication signal format of the signal received, and communicates the resulting signal.

First converter 160 converts a signal format compliant with the communication standard of the first power line communication used between building-side panel 100 and charging device 200 into a signal format compliant with another communication standard different from that of the first power line communication. For example, first converter 160 obtains the connection notification signal, output from charging device 200, by the first power line communication. At the point in time when first converter 160 obtains the connection notification signal from charging device 200, the connection notification signal is in a signal format compliant with the communication standard of the first power line communication.

First converter 160 converts the connection notification signal from the signal format compliant with the communication standard of the communication standard of the first power line communication to a signal format compliant with a wireless communication standard used by wireless communicator 161. Additionally, first converter 160 converts the connection notification signal from the signal format compliant with the communication standard of the communication standard of the first power line communication to a signal format compliant with a wired communication standard used by wired communicator 162.

Wireless communicator 161 is communication circuitry (a communication module) for building-side panel 100 to communicate wirelessly with gateway 500. The communication standard of the communication by wireless communicator 161 is not particularly limited as long as wireless communicator 161 is capable of communicating wirelessly. Wireless communicator 161 outputs the connection notification signal, for which the signal format has been converted, to gateway 500 or the like.

Wired communicator 162 is communication circuitry (a communication module) for first converter 160 to perform wired communication with controller 112 of power outage detector 110. The communication standard of the communication by wired communicator 162 is not particularly limited as long as wired communicator 162 is capable of wired communication. Wired communicator 162 is also connected to controller 112 by a communication cable (e.g., a Local Area Network (LAN) cable).

Charging device 200 is a device that is connected to an external device by power line PL1 and that charges electric vehicle V. In the present embodiment, the external device is electric meter 800, building-side panel 100, or the like, for example. In other words, charging device 200 is a device connected to commercial power supply P via power outage detector 110.

Charging device 200 is installed on the outside of house H, in a location adjacent to house H. When power can be supplied to any vehicle, and more specifically, even to a vehicle owned by another person who is not the user, power may be stolen. Accordingly, system 1 according to the present embodiment performs authentication processing with vehicles, and charging device 200 only charges authenticated vehicles (e.g., electric vehicle V). This prevents electricity theft.

Charging device 200 is supplied with power from building-side panel 100 (and more specifically, from commercial power supply P), and charges electric vehicle V. During power outages, charging device 200 supplies power from electric vehicle V to building-side panel 100 and residential distribution panel 300.

Charging device 200 includes communicator 210, second converter 220, third switch 230, fourth switch 240, calculator 250, and storage 260.

Communicator 210 is communication circuitry (a communication module) for charging device 200 to communicate with electric vehicle V by wired communication. The wired communication is communication of a communication standard different from that of the first power line communication. The wired communication may be communication over any communication cable, and may be communication over a LAN cable, for example. In the present embodiment, the wired communication is second power line communication using a lower voltage than the voltage supplied by a power line to which charging device 200 and the external device are connected (e.g., power line PL1).

As described above, a high voltage of 100 V or 200 V is supplied by power line PL1 to which charging device 200 and the external device are connected. Communicator 210 and electric vehicle V (and more specifically, communicator 430) are connected by power line PL3, and power line PL3 supplies a voltage of 12 V. The wired communication used by communicator 210 is, for example, communication over power line PL3, and is power line communication using a voltage of 12 V (the second power line communication). The value of the voltage supplied to the power line used is therefore different between the first power line communication and the second power line communication.

When electric vehicle V and charging device 200 are connected, communicator 210 obtains the connection notification signal, indicating that electric vehicle V and charging device 200 are connected, from electric vehicle V by wired communication. More specifically, communicator 210 obtains the connection notification signal by the second power line communication. Communicator 210 outputs the connection notification signal obtained to second converter 220.

Second converter 220 includes wired communicator 221. Second converter 220 is a communication module that receives a signal, converts the communication signal format of the signal received, and communicates the resulting signal. Second converter the connection notification signal obtained by 220 converts communicator 210 into a signal format compliant with the communication standard of the first power line communication by power line PL1. At the point in time when second converter 220 obtains the connection notification signal from communicator 210, the connection notification signal is in a signal format compliant with the communication standard of the second power line communication. Second converter 220 converts the connection notification signal obtained from the signal format compliant with the communication standard of the second power line communication to the signal format compliant with the communication standard of the first power line communication.

Second converter 220 performs the same processing on signals other than the connection notification signal. In other words, second converter 220 converts signals such as the connection notification signal from a signal format compliant with the communication standard of the second power line communication used by communicator 210 into a signal format compliant with the communication standard of the first power line communication used between building-side panel 100 and charging device 200.

Wired communicator 221 is communication circuitry (a communication module) for wired communication between charging device 200 and building-side panel 100. Wired communicator 221 performs first power line communication with building-side panel 100 (and more specifically, with first converter 160). Wired communicator 221 outputs the connection notification signal, converted into a signal format compliant with the communication standard of the first power line communication, to building-side panel 100 (and more specifically, to first converter 160).

Third switch 230 is a device that switches between opening and closing of power line PL4 provided between second converter 220 of charging device 200 and electric vehicle V, and more specifically, power line PL4 used to charge electric vehicle V. In other words, third switch 230 closes or opens a circuit formed between second converter 220 and electric vehicle V.

Fourth switch 240 is a device that switches between opening and closing of power line PL5 provided between charging device 200 and electric vehicle V, and more specifically, power line PL5 used to supply power from electric vehicle V to building-side panel 100 and residential distribution panel 300. In other words, third switch 230 closes or opens a circuit formed between building-side panel 100 and electric vehicle V.

Both third switch 230 and fourth switch 240 obtain control signals output from calculator 250, and switch the opening and closing of the corresponding power lines based on the control signals obtained.

Calculator 250 performs information processing for charging electric vehicle V, and for supplying power from electric vehicle V to building-side panel 100 and residential distribution panel 300. Calculator 250 is implemented by a microcomputer, for example, but may be implemented by a processor.

Calculator 250 controls communicator 210, second converter 220, third switch 230, and fourth switch 240, for example. In other words, calculator 250 controls communicator 210 to obtain the connection notification signal and output the connection notification signal to second converter 220. Calculator 250 also controls second converter 220 to convert the signal format of the connection notification signal obtained, and output the resulting signal to building-side panel 100. Calculator 250 also outputs control signals to control the opening and closing of third switch 230 and fourth switch 240.

Storage 260 is a storage device that stores control programs used for the information processing performed by calculator 250, various types of information used for the information processing, and the like. Storage 260 is implemented by semiconductor memory, for example.

Note that charging device 200 is provided with a charging cable, and electric vehicle V is charged by connecting charging device 200 to electric vehicle V with the charging cable. This charging cable includes power line PL3, power line PL4, and power line PL5.

Residential distribution panel 300 obtains the power supplied from commercial power supply P or charging device 200 via building-side panel 100, and distributes power to a plurality of loads provided in house H. Residential distribution panel 300 is also connected to commercial power supply P via power outage detector 110.

Residential distribution panel 300 is a distribution panel including second main breaker 310 and a plurality of branch breakers 321, 322, 323, 324, 325, and 326.

Second main breaker 310 obtains power supplied from commercial power supply P or charging device 200 (and more specifically, electric vehicle V), and distributes the power to the plurality of branch breakers 321 to 326. Second main breaker 310 may use a single-phase three-wire power distribution system, for example. Second main breaker 310 is connected to first main breaker 130 by a power line. Second main breaker 310 has a function for detecting leakage, and cuts off the circuit when leakage is detected.

Each of the plurality of branch breakers 321 to 326 is connected to second main breaker 310. Each of the plurality of branch breakers 321 to 326 is also connected to a corresponding load (household appliance) in house H.

Electric vehicle V, gateway 500, control server 600, mobile terminal 700, and electric meter 800 will also be described as constituent elements of system 1.

Electric vehicle V is a vehicle such as a Plug-in Hybrid Vehicle (PHV) or a Battery Electric Vehicle (BEV).

Electric vehicle V includes AC/DC converter 410, storage battery 420, communicator 430, calculator 440, and storage 450.

AC/DC converter 410 converts AC power supplied from charging device 200 into DC power. The DC power resulting from the conversion is stored in storage battery 420. During a power outage, AC/DC converter 410 converts DC power, which is the power stored in storage battery 420, into AC power. The AC power resulting from the conversion by AC/DC converter 410 is supplied to residential distribution panel 300 via charging device 200 and building-side panel 100. More specifically, the AC power resulting from the conversion by AC/DC converter 410 is supplied to second main breaker 310 of residential distribution panel 300 via fourth switch 240 of charging device 200 and second switch 150 of building-side panel 100.

As illustrated in FIG. 2, AC/DC converter 410 is connected to power line PL4 (an input power line), which is used to charge electric vehicle V, and power line PL5 (an output power line), which is used to supply power from electric vehicle V to building-side panel 100 and residential distribution panel 300.

Storage battery 420 is a battery that stores power (DC power) for driving a drive unit of electric vehicle V. Storage battery 420 is a secondary battery such as a lithium-ion battery, but may be a capacitor or the like.

Communicator 430 is communication circuitry (a communication module) for electric vehicle V to communicate with charging device 200 by wired communication. The wired communication performed by communicator 430 and by communicator 210 of charging device 200 is the same communication.

Calculator 440 performs information processing for charging storage battery 420 and for supplying power to charging device 200. Calculator 440 is implemented by a microcomputer, for example, but may be implemented by a processor. Calculator 440 controls AC/DC converter 410, storage battery 420, and communicator 430.

Storage 450 is a storage device that stores control programs used for the information processing performed by calculator 440, various types of information used for the information processing, and the like. Storage 450 is implemented by semiconductor memory, for example.

In addition, electric vehicle V detects that the charging cable of charging device 200 is connected when the charging cable is connected to electric vehicle V. Electric vehicle V detects that the charging cable is connected as follows, for example. When charging device 200 and electric vehicle V are connected by the charging cable, a voltage of 12 V is supplied from electric vehicle V to charging device 200. Charging device 200 includes a voltmeter (not shown), and when the voltmeter detects that a voltage of 12 V is supplied, communicator 210 outputs voltage supply information, indicating that a voltage of 12 V is supplied, to communicator 430 by the second power line communication over power line PL3. When communicator 430 obtains the voltage supply information, electric vehicle V (and more specifically, calculator 440) determines that the charging cable is connected, i.e., detects that the charging cable is connected.

Gateway 500 is a communication device for first converter 160 (wireless communicator 161) to communicate with control server 600 and mobile terminal 700 over a wide-area communication network such as Internet 10. Gateway 500 is installed within house H. Gateway 500 includes wireless communicator 510 and wired communicator 520.

Wireless communicator 510 is communication circuitry (a communication module) for gateway 500 to communicate wirelessly with building-side panel 100 (wireless communicator 161). The communication standard of the communication by wireless communicator 510 is not particularly limited as long as wireless communicator 510 is capable of communicating wirelessly.

Wired communicator 520 is communication circuitry (a communication module) for gateway 500 to communicate with control server 600 and mobile terminal 700 over a wide-area communication network such as Internet 10. The communication standard of the communication by wired communicator 520 is not particularly limited as long as wired communicator 520 is capable of wired communication.

Control server 600 is a device that performs information processing based on information output from gateway 500 and mobile terminal 700, respectively, and is implemented by one or more web servers (cloud servers). Specifically, control server 600 includes communicator 610, calculator 620, and storage 630.

Communicator 610 is communication circuitry (a communication module) for control server 600 to communicate with gateway 500 and mobile terminal 700. Communicator 610 communicates using a wide-area communication network, for example. This communication may be wired communication or wireless communication.

Calculator 620 performs information processing for charging electric vehicle V, and for supplying power from electric vehicle V to building-side panel 100 and residential distribution panel 300. Calculator 620 is implemented by a microcomputer, for example, but may be implemented by a processor.

Storage 630 is a storage device that stores information necessary for the information processing by calculator 620, computer programs executed by calculator 620, and the like. Storage 630 may be implemented as a Hard Disk Drive (HDD), for example, but may be implemented as semiconductor memory or the like.

Mobile terminal 700 is an information terminal carried by a user of system 1 (e.g., a resident of house H). Mobile terminal 700 is a smartphone owned by the user, for example, but may be a dedicated device of system 1, a tablet terminal, or the like.

Mobile terminal 700 includes operation acceptor 710, display 720, wireless communicator 730, calculator 740, and storage 750.

Operation acceptor 710 accepts operations from the user or the like. Operation acceptor 710 is implemented by a touch panel, for example, but may be implemented by hardware keys or the like.

Display 720 displays images. Display 720 is realized by a display panel such as a liquid crystal panel, an organic electroluminescence (EL) panel, or the like, for example.

Wireless communicator 730 is communication circuitry (a communication module) for mobile terminal 700 to communicate wirelessly with gateway 500 and control server 600. Wireless communicator 730 communicates using a wide-area communication network, for example.

Calculator 740 performs information processing related to system 1 based on operations accepted by operation acceptor 710. Calculator 740 is implemented by a microcomputer, for example, but may be implemented by a processor. Calculator 740 controls operation acceptor 710, display 720, and wireless communicator 730.

Storage 750 is a storage device that stores control programs used for the information processing performed by calculator 740, various types of information used for the information processing, and the like. Storage 750 is implemented by semiconductor memory, for example.

Electric meter 800 measures the amount of power used in house H. Electric meter 800 has a power metering function, and is a smart meter, for example. The power metering function is implemented by a current sensor (a current transformer (CT)), for example.

Operation Examples 1 to 4, which describe methods performed by system 1 according to the present embodiment, will be described next.

### Operation Example 1

Operation Example 1 is an example of operations in which charging device 200 charges electric vehicle V. In other words, in this operation example, charging device 200 charges electric vehicle V only when authentication processing is performed with electric vehicle V and the authentication succeeds.

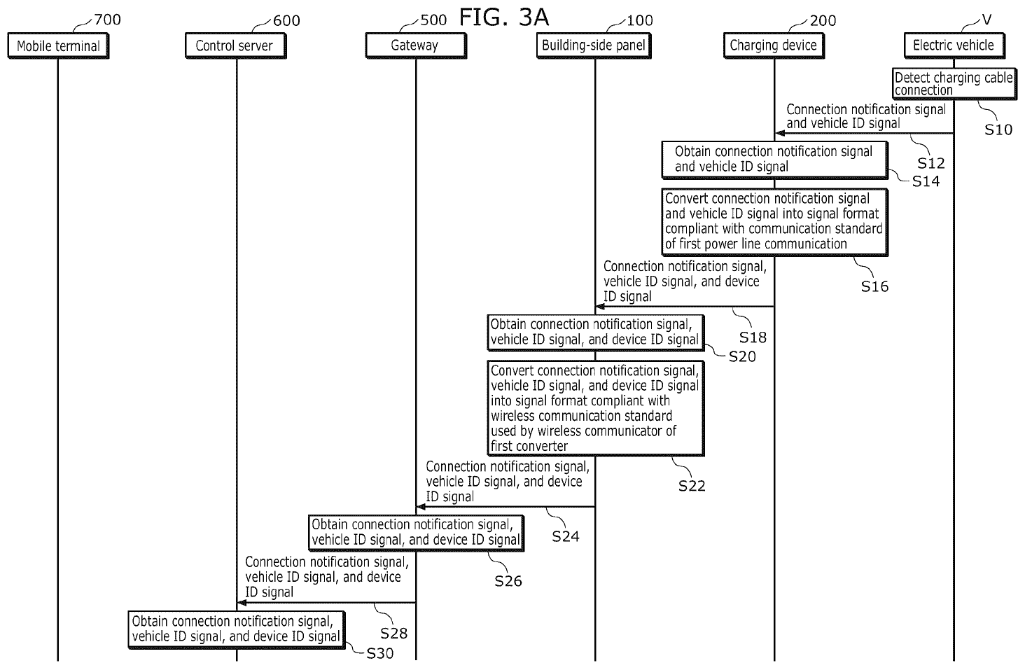

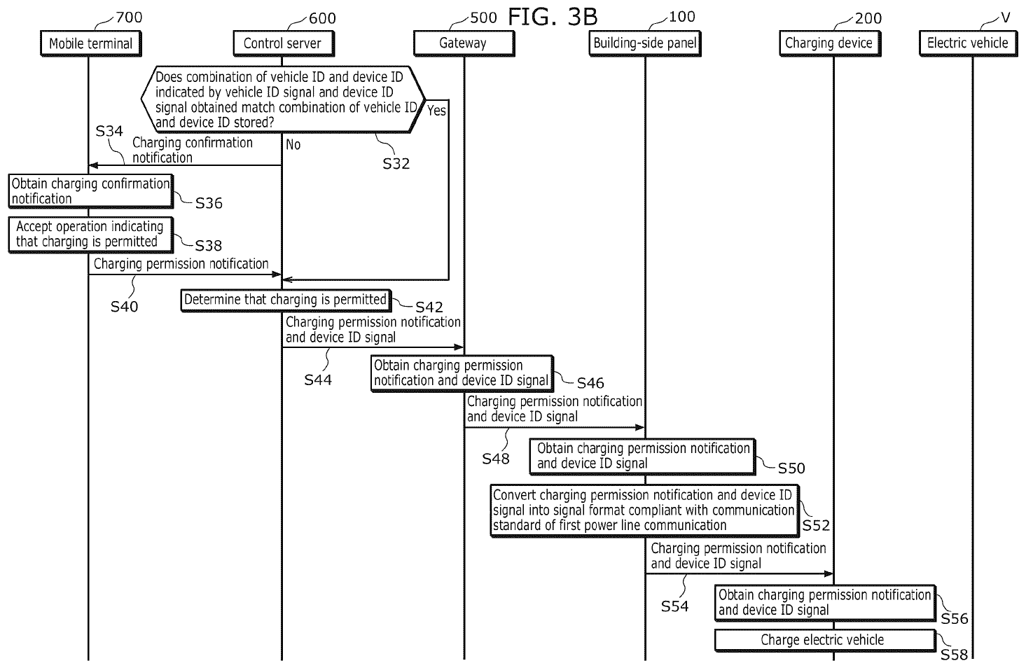

FIGS. 3A and 3B are sequence charts of Operation Example 1 performed by system 1 according to the present embodiment. More specifically, FIGS. 3A and 3B are sequence charts of Operation Example 1 performed by system 1, and by the constituent elements of system 1, respectively. The processing illustrated in FIG. 3B is performed after the processing illustrated in FIG. 3A is performed.

Prior to Operation Example 1 illustrated in FIG. 3A being performed, first switch 120 is in a closed state, and second switch 150, third switch 230, and fourth switch 240 are in an open state. In other words, first switch 120 closes the circuit, and second switch 150, third switch 230, and fourth switch 240 open the circuit. Charging device 200 is not charging electric vehicle V, and is in a stopped state.

First, the charging cable is connected to electric vehicle V. As a result, electric vehicle V (and more specifically, calculator 440) detects that the charging cable is connected (S10). Electric vehicle V detects that the charging cable is connected by communicator 430 of electric vehicle V obtaining the voltage supply information, for example.

During the period when charging device 200 and electric vehicle V are connected, communicator 210 periodically (e.g., once per second) outputs the voltage supply information to communicator 430 by the second power line communication.

Next, communicator 430 of electric vehicle V outputs the connection notification signal, indicating that electric vehicle V and charging device 200 are connected, to communicator 210 of charging device 200 (S12). The connection notification signal is a signal indicating that electric vehicle V and charging device 200 are connected, and more specifically, that electric vehicle V and charging device 200 are connected by the charging cable. Communicator 430 outputs the connection notification signal to communicator 210 by wired communication. In the present embodiment, the wired communication is the second power line communication over power line PL3.

In step S12, communicator 430 also outputs, to communicator 210, a vehicle identifier (ID) signal indicating a vehicle ID associated with the connection notification signal. The vehicle ID is an identifier for identifying electric vehicle V, and more specifically, is an identifier for distinguishing electric vehicle V from other vehicles. The vehicle ID is, for example, a vehicle identification number (VIN), but is not limited thereto. In this manner, communicator 430 outputs the connection notification signal and the vehicle ID signal to communicator 210. Note that the vehicle ID is stored in storage 450 of electric vehicle V in advance.

Next, communicator 210 of charging device 200 obtains the connection notification signal and the vehicle ID signal output from communicator 430 (S14). Note that in steps S12 and S14, the connection notification signal and the vehicle ID signal are signals in a signal format compliant with the communication standard of the second power line communication.

Second converter 220 of charging device 200 converts the connection notification signal and the vehicle ID signal obtained by communicator 210 into a signal format compliant with the communication standard of the first power line communication (S16). In other words, second converter 220 converts the connection notification signal and the vehicle ID signal, which were in the signal format compliant with the communication standard of the second power line communication, into the signal format compliant with the communication standard of the first power line communication.

Furthermore, second converter 220 outputs the connection notification signal and the vehicle ID signal, which have been converted into the signal format compliant with the communication standard of the first power line communication, to an external device (here, building-side panel 100) by the first power line communication (S18). At this time, second converter 220 also outputs a device ID signal, indicating a device ID of charging device 200, to building-side panel 100. The device ID is an identifier for distinguishing charging device 200 from other charging devices, e.g., a serial number, but is not limited thereto. The device ID is stored in storage 260 in advance. The device ID signal output by second converter 220 is also a signal in the signal format compliant with the communication standard of the first power line communication.

Note that second converter 220 multiplexes the connection notification signal, the vehicle ID signal, and the device ID signal on power line PL1, and outputs those signals to building-side panel 100 (and more specifically, to first converter 160) by first power line communication. In other words, when charging device 200 is not charging electric vehicle V, second converter 220 outputs the connection notification signal, the vehicle ID signal, and the device ID signal that have been converted into the signal format compliant with the communication standard of the first power line communication.

First converter 160 of building-side panel 100 obtains the connection notification signal, the vehicle ID signal, and the device ID signal (S20).

First converter 160 converts the connection notification signal, the vehicle ID signal, and the device ID signal obtained into a signal format compliant with the wireless communication standard used by wireless communicator 161 (S22). In other words, first converter 160 converts the connection notification signal, the vehicle ID signal, and the device ID signal, which were in the signal format compliant with the communication standard of the first power line communication, into the signal format compliant with the wireless communication standard used by wireless communicator 161.

Next, wireless communicator 161 of first converter 160 outputs the connection notification signal, the vehicle ID signal, and the device ID signal, for which the signal format has been converted, to gateway 500 (and more specifically, to wireless communicator 510) (S24).

Next, wireless communicator 510 of gateway 500 obtains the connection notification signal, the vehicle ID signal, and the device ID signal output by wireless communicator 161 (S26). Gateway 500 then converts the connection notification signal, the vehicle ID signal, and the device ID signal obtained by wireless communicator 510 into a predetermined first protocol. The predetermined first protocol is a protocol used in a wide-area communication network, such as Internet 10. Wired communicator 520 of gateway 500 outputs the connection notification signal, the vehicle ID signal, and the device ID signal converted into the predetermined first protocol to control server 600 (and more specifically, to communicator 610) (S28).

Communicator 610 of control server 600 obtains the connection notification signal, the vehicle ID signal, and the device ID signal output by wired communicator 520 (S30).

Calculator 620 of control server 600 then performs authentication processing on the vehicle ID signal and the device ID signal obtained by communicator 610. Calculator 620 determines whether a combination of the vehicle ID indicated by the vehicle ID signal obtained and the device ID indicated by the device ID signal obtained matches a combination of a vehicle ID and a device ID stored in advance in storage 630 (S32). In the present embodiment, storage 630 stores the vehicle ID of electric vehicle V and the device ID of charging device 200 as one combination. For simplicity, the combination of the vehicle ID indicated by the vehicle ID signal obtained and the device ID indicated by the device ID signal obtained may be referred to as a “first combination”, and the combination of a vehicle ID and a device ID stored in advance in storage 630 may be referred to as a “second combination”. If the vehicle ID indicated by the vehicle ID signal obtained is the vehicle ID of electric vehicle V and the device ID indicated by the device ID signal obtained is the device ID of charging device 200, calculator 620 determines that the first combination matches the second combination.

If calculator 620 determines that the first combination matches the second combination (Yes in step S32), calculator 620 determines that charging device 200 is permitted to charge electric vehicle V (S42).

If charging of electric vehicle V is permitted, communicator 610 outputs a charging permission notification indicating that charging of electric vehicle V is permitted, and the device ID signal indicating the device ID of charging device 200, to wired communicator 520 of gateway 500 (S44).

Wired communicator 520 obtains the charging permission notification and the device ID signal output by communicator 610 (S46). Gateway 500 then converts the charging permission notification and the device ID signal obtained by wired communicator 520 into a predetermined second protocol. The predetermined second protocol is a protocol used by wireless communicator 510. Wireless communicator 510 outputs the charging permission notification and the device ID signal, which have been converted into the predetermined second protocol, to first converter 160 of building-side panel 100 (S48).

First converter 160 (and more specifically, wireless communicator 161) obtains the charging permission notification and the device ID signal output by wireless communicator 510 (S50).

First converter 160 converts the charging permission notification and the device ID signal obtained into the signal format compliant with the communication standard of the first power line communication (S52). In other words, first converter 160 converts the charging permission notification and the device ID signal, which were in the signal format compliant with the wireless communication standard used by wireless communicator 161, into the signal format compliant with the communication standard of the first power line communication.

Next, first converter 160 outputs the charging permission notification and the device ID signal, for which the signal format has been converted, to second converter 220 of charging device 200 (S54). Note that first converter 160 multiplexes the charging permission notification and the device ID signal on power line PL1, and outputs those items to second converter 220 by the first power line communication.

Second converter 220 obtains the charging permission notification and the device ID signal output by first converter 160 (S56). When the charging permission notification and the device ID signal are obtained by second converter 220, calculator 250 controls third switch 230 to shift from the open state to the closed state. More specifically, calculator 250 outputs a control signal instructing a shift to the closed state to third switch 230, and third switch 230 obtains the control signal and shifts to the closed state. As a result, third switch 230 closes the circuit, i.e., the circuit formed by commercial power supply P, building-side panel 100, charging device 200, and electric vehicle V, and charging device 200 therefore charges electric vehicle V (S58). Charging device 200 charges electric vehicle V (and more specifically, storage battery 420) at 100 V or 200 V over power line PL4. In step S58, charging device 200 is charging electric vehicle V, and is therefore in a power supply state. The vehicle ID of electric vehicle V being charged is stored in storage 260 of charging device 200.

A case where, for example, the charging cable is connected to another vehicle aside from electric vehicle V in step S10, and the other vehicle detects that the charging cable is connected, will be described here as well. In this case, steps S10 to S32 are performed as illustrated in FIGS. 3A and 3B. Then, in step S32, calculator 620 determines that the first combination does not match the second combination. In other words, in this case, the vehicle ID indicated by the vehicle ID signal obtained is the vehicle ID of the other vehicle, whereas the device ID indicated by the device ID signal obtained is the device ID of charging device 200.

If calculator 620 determines that the first combination does not match the second combination (No in step S32), communicator 610 outputs a charging confirmation notification to mobile terminal 700 (and more specifically, to wireless communicator 730) (S34). The charging confirmation notification is a notification made when another vehicle aside from electric vehicle V is connected to charging device 200, to obtain permission for charging device 200 to charge that other vehicle.

Wireless communicator 730 of mobile terminal 700 obtains the charging confirmation notification output by communicator 610 (S36). When wireless communicator 730 obtains the charging confirmation notification, calculator 740 controls display 720 to display an image indicating that another vehicle aside from electric vehicle V is connected to charging device 200 and that charging device 200 is requesting permission to charge that other vehicle. The image is stored in storage 750, for example.

When the image is displayed in display 720, operation acceptor 710 accepts an operation indicating that the user permits charging of the other vehicle (S38). When this operation is accepted, wireless communicator 730 outputs the charging permission notification to communicator 610 (S40). Then, when communicator 610 obtains the charging permission notification output, calculator 620 determines, in step S42, that charging device 200 is permitted to charge electric vehicle V. The processing of step S44 and on is performed thereafter.

Note that if operation acceptor 710 has not accepted an operation in step S38, i.e., if the user does not permit the other vehicle to be charged, the processing of Operation Example 1 ends.

In this operation example, steps S12 to S56 correspond to authentication processing.

Charging device 200 according to this operation example can be summarized as follows.

The communication between charging device 200 (communicator 210) and electric vehicle V (communicator 430) is wired communication, and the wired communication is communication that is different from the first power line communication over power line PL1 between charging device 200 and an external device (e.g., building-side panel 100 or electric meter 800). Power line PL1 is a power line used to charge electric vehicle V, and supplies a voltage of at least 100 V.

For example, in the system described in other patent literature (Japanese Unexamined Patent Application Publication No. 2012-151914), the communication between the electric vehicle and the charging device is power line communication using a power line. High voltages, such as 100 V or 200 V, are applied to the power line, and performing power line communication therefore produces electromagnetic noise. This in turn results in problems such as difficulty in charging the electric vehicle.

However, in the present embodiment, the wired communication is communication different from the first power line communication. Accordingly, a high voltage such as 100 V or 200 V will not be applied even if communicator 430 outputs a connection notification signal to communicator 210 by that wired communication, i.e., even if that wired communication is performed. This makes it difficult for electromagnetic noise to be produced by the wired communication, and problems such as difficulty in charging electric vehicle V are less likely to occur. In particular, problems such as difficulty in charging electric vehicle V are less likely to occur in the period when charging device 200 and electric vehicle V are connected, i.e., when the voltage supply information is output by communicator 210 to communicator 430 periodically during charging.

Charging device 200 capable of charging electric vehicle V more reliably is achieved as a result.

### Operation Example 2

Operation Example 2 is an example of operations in which the charging of electric vehicle V by charging device 200 is stopped.

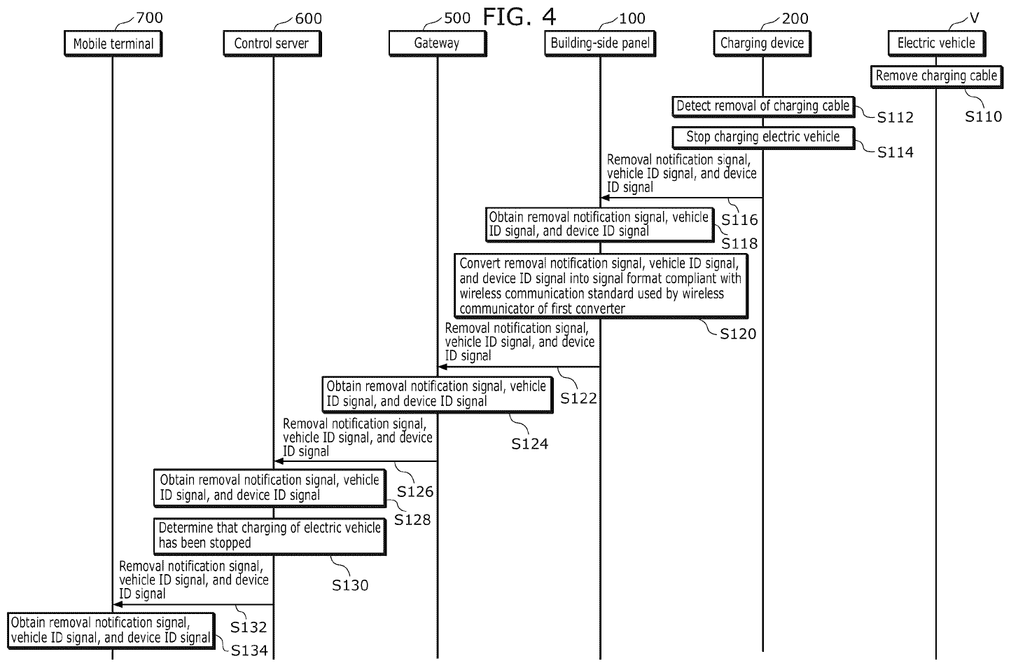

FIG. 4 is a sequence chart illustrating Operation Example 2 of system 1 according to the present embodiment. More specifically, FIG. 4 is a sequence chart of Operation Example 2 performed by system 1, and by the constituent elements of system 1, respectively.

Prior to Operation Example 2 illustrated in FIG. 4 being performed, first switch 120 and third switch 230 are in a closed state, and second switch 150 and fourth switch 240 are in an open state. In other words, first switch 120 and third switch 230 close the circuit, and second switch 150 and fourth switch 240 open the circuit. Charging device 200 is charging electric vehicle V, and is therefore in a power supply state.

First, the charging cable is removed from electric vehicle V (S110). As a result, charging device 200 detects that the charging cable has been removed (S112).

Charging device 200 detects that the charging cable has been removed as follows, for example. As described above, when charging device 200 and electric vehicle V are connected by the charging cable, a voltage of 12 V is supplied from electric vehicle V to charging device 200, and the voltmeter provided in charging device 200 detects that a voltage of 12 V is being supplied. During the charging of electric vehicle V, the voltmeter periodically (e.g., once per second) detects that a voltage of 12 V is being supplied. When the charging cable is removed from electric vehicle V in step S110, the voltmeter can no longer detect that a voltage of 12 V is being supplied. When the voltmeter can no longer detect that a voltage of 12 V is being supplied, charging device 200 (and more specifically, calculator 250) determines that the charging cable has been removed, i.e., detects that the charging cable has been removed.

When the charging cable is detected as having been removed, calculator 250 controls third switch 230 to shift from the closed state to the open state. More specifically, calculator 250 outputs a control signal instructing a shift to the open state to third switch 230, and third switch 230 obtains the control signal and shifts to the open state. As a result, third switch 230 opens the circuit, and charging device 200 stops charging electric vehicle V (S114). In other words, charging device 200 is not charging electric vehicle V, and is in a stopped state.

Second converter 220 outputs a removal notification signal, the vehicle ID signal, and the device ID signal to first converter 160 of building-side panel 100 by the first power line communication (S116). The removal notification signal is a signal indicating that the charging cable is detected as having been removed in step S112. The vehicle ID signal is the vehicle ID signal of electric vehicle V subject to charging in Operation Example 1. As described with respect to step S56 of Operation Example 1, the vehicle ID of electric vehicle V subject to charging is stored in storage 260. Second converter 220 obtains the vehicle ID stored in storage 260, and outputs the vehicle ID signal indicating the vehicle ID. Second converter 220 outputs the removal notification signal, the vehicle ID signal, and the device ID signal, which are in the signal format compliant with the communication standard of the first power line communication, to first converter 160.

First converter 160 obtains the removal notification signal, the vehicle ID signal, and the device ID signal (S118).

First converter 160 converts the removal notification signal, the vehicle ID signal, and the device ID signal obtained into a signal format compliant with the wireless communication standard used by wireless communicator 161 (S120). In other words, first converter 160 converts the removal notification signal, the vehicle ID signal, and the device ID signal, which were in the signal format compliant with the communication standard of the first power line communication, into the signal format compliant with the wireless communication standard used by wireless communicator 161.

Next, wireless communicator 161 of first converter 160 outputs the removal notification signal, the vehicle ID signal, and the device ID signal, for which the signal format has been converted, to gateway 500 (and more specifically, to wireless communicator 510) (S122).

Next, wireless communicator 510 of gateway 500 obtains the removal notification signal, the vehicle ID signal, and the device ID signal output by wireless communicator 161 (S124). Gateway 500 then converts the removal notification signal, the vehicle ID signal, and the device ID signal obtained by wireless communicator 510 into the predetermined first protocol. Wired communicator 520 of gateway 500 outputs the removal notification signal, the vehicle ID signal, and the device ID signal converted into the predetermined first protocol to control server 600 (and more specifically, to communicator 610) (S126).

Communicator 610 of control server 600 obtains the removal notification signal, the vehicle ID signal, and the device ID signal output by wired communicator 520 (S128).

When communicator 610 obtains the removal notification signal, the vehicle ID signal, and the device ID signal, calculator 620 of control server 600 determines that the charging of electric vehicle V has been stopped (S130).

When calculator 620 determines that the charging of electric vehicle V has been stopped, communicator 610 outputs the removal notification signal, the vehicle ID signal, and the device ID signal to mobile terminal 700 (and more specifically, to wireless communicator 730) (S132).

Wireless communicator 730 obtains the removal notification signal, the vehicle ID signal, and the device ID signal output by communicator 610 (S134). When wireless communicator 730 obtains the removal notification signal, the vehicle ID signal, and the device ID signal, calculator 740 controls display 720 to display an image indicating that the charging of electric vehicle V has been stopped. The image is stored in storage 750, for example.

This enables the user to understand that the charging of electric vehicle V has been stopped.

### Operation Example 3

Operation Example 3 is an example of operations in which power is supplied from electric vehicle V to house H in the event of a power outage in commercial power supply P.

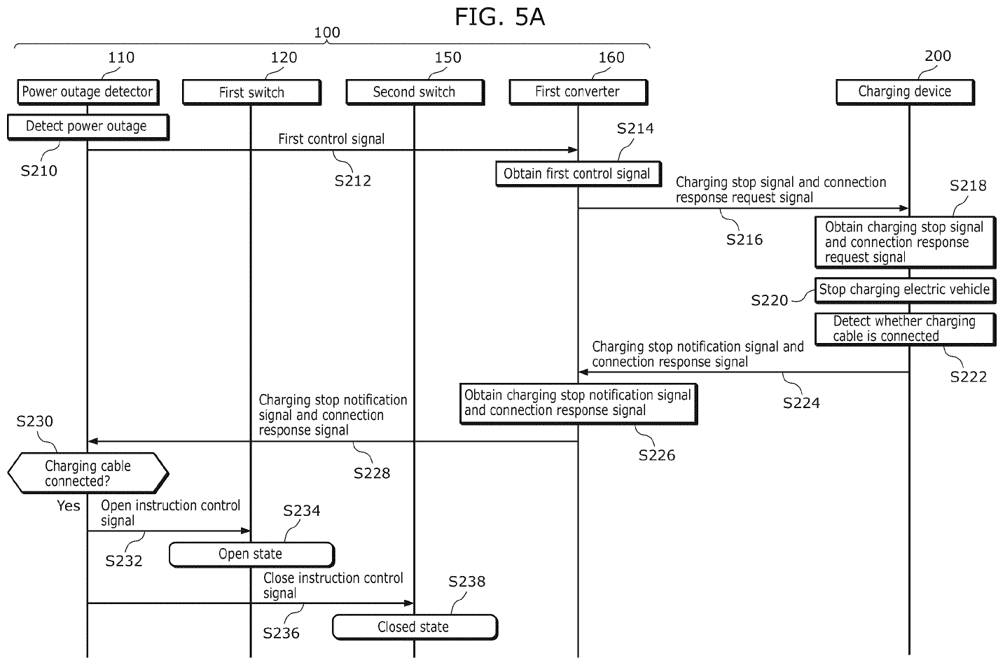

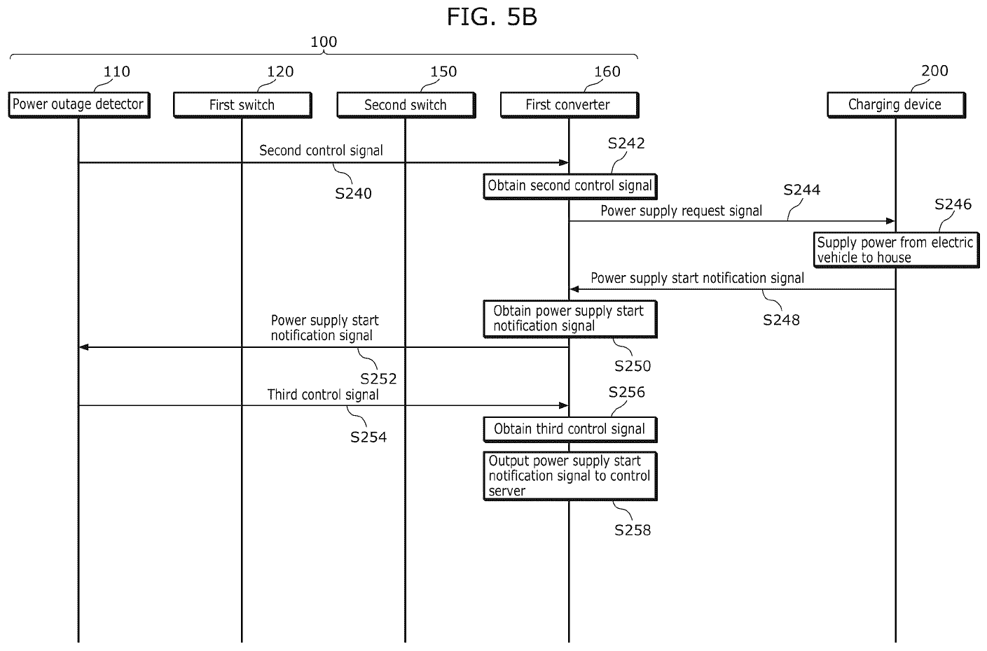

FIGS. 5A and 5B are sequence charts of Operation Example 3 performed by system 1 according to the present embodiment. The processing illustrated in FIG. 5B is performed after the processing illustrated in FIG. 5A is performed.

Prior to Operation Example 3 illustrated in FIG. 5A being performed, first switch 120 and third switch 230 are in a closed state, and second switch 150 and fourth switch 240 are in an open state. In other words, first switch 120 and third switch 230 close the circuit, and second switch 150 and fourth switch 240 open the circuit. Charging device 200 is charging electric vehicle V, and is therefore in a power supply state.

First, power outage detector 110 detects a power outage based on a voltage supplied from commercial power supply P (S210).

As described above, controller 112 obtains the voltage value output from voltmeter 111, and determines that a power outage has occurred in commercial power supply P when the voltage value obtained is less than a predetermined value (threshold).

Then, when a power outage is detected in step S210, controller 112 outputs a first control signal to first converter 160 (S212). First converter 160 obtains the first control signal output from controller 112 (S214).

When first converter 160 obtains the first control signal, first converter 160 outputs a charging stop signal and a connection response request signal to second converter 220 of charging device 200 (S216). The charging stop signal is a signal instructing charging device 200 to stop charging electric vehicle V. Upon obtaining the charging stop signal, charging device 200 stops charging electric vehicle V. The connection response request signal is a signal requesting a response indicating whether the charging cable of charging device 200 which obtained the connection response request signal is connected to electric vehicle V. Upon obtaining the connection response request signal, charging device 200 makes a response indicating whether the charging cable is connected to electric vehicle V. Note that first converter 160 multiplexes the charging stop signal and the connection response request signal on power line PL1, and outputs those signals to second converter 220 by the first power line communication.

In this manner, in steps S212 to S216, controller 112 controls first converter 160 to output the charging stop signal and the connection response request signal to second converter 220.

Second converter 220 of charging device 200 obtains the charging stop signal and the connection response request signal output by first converter 160 (S218).

Calculator 250 of charging device 200 stops charging electric vehicle V in accordance with the charging stop signal obtained (S220). More specifically, calculator 250 outputs a control signal instructing a shift to the open state to third switch 230, and third switch 230 obtains the control signal and shifts to the open state. As a result, third switch 230 opens the circuit, and charging device 200 stops charging electric vehicle V.

Calculator 250 of charging device 200 senses whether the charging cable is connected to electric vehicle V in accordance with the connection response request signal obtained (S222). For example, calculator 250 of charging device 200 detects whether the charging cable is connected as follows. When charging device 200 and electric vehicle V are connected by the charging cable, a voltage of 12 V is supplied from electric vehicle V to charging device 200, and the voltmeter provided in charging device 200 detects that the voltage of 12 V is being supplied. When the voltmeter detects that the voltage of 12 V is being supplied, calculator 250 determines that the charging cable is connected, i.e., detects that the charging cable is connected. When the voltmeter does not detect that the voltage of 12 V is being supplied, calculator 250 determines that the charging cable is not connected, i.e., detects that the charging cable is not connected.

Second converter 220 of charging device 200 then outputs a charging stop notification signal and a connection response signal to first converter 160 (S224). The charging stop notification signal is a signal for making a notification that the charging of electric vehicle V has been stopped in step S220. The connection response signal is a signal indicating the detection result from step S222, and the detection result indicates whether the charging cable is connected to electric vehicle V. Note that second converter 220 multiplexes the charging stop notification signal and the connection response signal on power line PL1, and outputs those signals to first converter 160 by the first power line communication.

First converter 160 obtains the charging stop notification signal and the connection response signal output by second converter 220 (S226). Furthermore, first converter 160 outputs the charging stop notification signal and the connection response signal obtained to controller 112 of power outage detector 110 (S228).

Controller 112 obtains the charging stop notification signal and the connection response signal output by first converter 160. Controller 112 then determines whether the charging cable is connected based on the connection response signal obtained (S230).

When the connection response signal indicates that the charging cable is connected, controller 112 determines that the charging cable is connected. When the connection response signal indicates that the charging cable is not connected, controller 112 determines that the charging cable is not connected.

When controller 112 determines that the charging cable is connected (Yes in step S230), controller 112 outputs the control signals described below to first switch 120, second switch 150, and first converter 160.

First, controller 112 outputs a control signal instructing first switch 120 to shift to the open state (an open instruction control signal) to first switch 120 (S232), and first switch 120 obtains the open instruction control signal and shifts to the open state (S234). First switch 120 opens the circuit as a result. In other words, when a power outage is detected in step S210, first switch 120 is opened.

Next, controller 112 outputs a control signal instructing second switch 150 to shift to the closed state (a close instruction control signal) to second switch 150 (S236), and second switch 150 obtains the close instruction control signal and enters the closed state (S238). Second switch 150 closes the circuit as a result. In other words, when a power outage is detected in step S210, second switch 150 is closed.

Next, controller 112 outputs a second control signal to first converter 160 (S240). First converter 160 obtains the second control signal output from controller 112 (S242).

When first converter 160 obtains the second control signal, first converter 160 outputs a power supply request signal to second converter 220 of charging device 200 (S244). The power supply request signal is a signal for requesting power to be supplied from electric vehicle V to house H. Note that first converter 160 multiplexes the power supply request signal on power line PL1, and outputs that signals to second converter 220 by the first power line communication.

In this manner, in steps S240 to S244, controller 112 controls first converter 160 to output the power supply request signal to second converter 220.

When second converter 220 obtains the power supply request signal output by first converter 160, charging device 200 (calculator 250) supplies power from electric vehicle V to house H in accordance with the power supply request signal obtained (S246). Specifically, calculator 250 outputs a control signal instructing a shift to the closed state to fourth switch 240, and fourth switch 240 obtains the control signal and shifts to the closed state. Fourth switch 240 closes the circuit as a result.

Next, second converter 220 of charging device 200 outputs a power supply start notification signal to first converter 160 (S248). The power supply start notification signal is a signal for making a notification that the supply of power from electric vehicle V to house H has been started in step S246.

First converter 160 obtains the power supply start notification signal output by second converter 220 (S250). Furthermore, first converter 160 outputs the power supply start notification signal obtained to controller 112 of power outage detector 110 (S252).

Upon obtaining the power supply start notification signal output by first converter 160, controller 112 outputs a third control signal to first converter 160 (S254). First converter 160 obtains the third control signal output from controller 112 (S256).

When first converter 160 obtains the third control signal, first converter 160 outputs the power supply start notification signal to communicator 610 of control server 600 via gateway 500 (S258).

In this manner, in steps S254 to S258, controller 112 controls first converter 160 to output the power supply start notification signal to communicator 610.

Next, communicator 610 obtains the power supply start notification signal output, and the power supply start notification signal obtained is stored in storage 630. In step S258, first converter 160 may output the power supply start notification signal to wireless communicator 730 of mobile terminal 700. When wireless communicator 730 obtains the power supply start notification signal, calculator 740 controls display 720 to display an image indicating that the supply of power from electric vehicle V to house H has been started. The image is stored in storage 750, for example. This enables the user to understand that the supply of power from electric vehicle V to house H has been started.

Note that the processing of Operation Example 3 ends when controller 112 determines that the charging cable is not connected (No in step S230).

In addition, when in step S246 charging device 200 supplies power from electric vehicle V to house H, residential distribution panel 300 (second main breaker 310) to which power is supplied may supply the supplied AC voltage to a predetermined load among the plurality of loads.

The predetermined load (a predetermined household appliance) is, for example, a load that requires continuous operation, such as a refrigerator or an air conditioner. Second main breaker 310 supplies power to a predetermined branch breaker, among the plurality of branch breakers 321 to 326, that is connected to the predetermined load.

The predetermined load is not limited thereto, however, and may be a load which the user desires to operate. In this case, before a power outage occurs, operation acceptor 710 accepts, from the user, an operation instructing a load which the user wishes to operate. Wireless communicator 730 outputs a signal, indicating the load instructed by the operation accepted, to controller 112 via gateway 500 and first converter 160, and controller 112 obtains the signal output. Controller 112 controls second main breaker 310 to supply power to a predetermined branch breaker that is connected to the load (the predetermined load) indicated by the signal obtained.

System 1 according to this operation example can be summarized as follows.

As described above, during a power outage, AC/DC converter 410 converts DC power, which is the power stored in storage battery 420, into AC power, and outputs the AC power. After a power outage is detected, second switch 150 shifts to a closed state in step S238, and fourth switch 240 shifts to a closed state in step S246. As a result, AC/DC converter 410 supplies the AC power to residential distribution panel 300 via fourth switch 240 and second switch 150. In other words, in this operation example, when a power outage is detected, second switch 150 is closed, and the AC voltage supplied from electric vehicle V is supplied to residential distribution panel 300. The supplied AC voltage is then supplied to each of the plurality of loads via second main breaker 310 and the plurality of branch breakers 321 to 326.

In the system described in PTL 1, the voltage supplied from the electric vehicle is DC voltage, and it is therefore necessary for household appliances in the house to be devices capable of handling DC voltage. This system was therefore inconvenient for users.

However, in this operation example, the voltage supplied from electric vehicle V to each of the plurality of loads (the plurality of household appliances) during a power outage is AC voltage, and the household appliances in house H therefore need only handle AC voltage. In general, the voltage supplied from commercial power supply P is AC voltage, and the user therefore need not prepare special household appliances (i.e., household appliances capable of handling DC voltage) for the event of a power outage. Accordingly, system 1 according to the present embodiment can be said to be a system which is highly convenient for users.

Furthermore, building-side panel 100 according to this operation example can be summarized as follows.

After a power outage is detected, first switch 120 is in an open state in step S234, which suppresses reverse power flow to commercial power supply P, even when power is supplied from electric vehicle V to house H during the power outage. In other words, building-side panel 100 which makes reverse power flow unlikely to occur is realized.

### Operation Example 4

Operation Example 4 is an example of operations in which after commercial power supply P experiences a power outages and power is supplied from electric vehicle V to house H, i.e., after Operation Example 3, commercial power supply P recovers from the power outage.

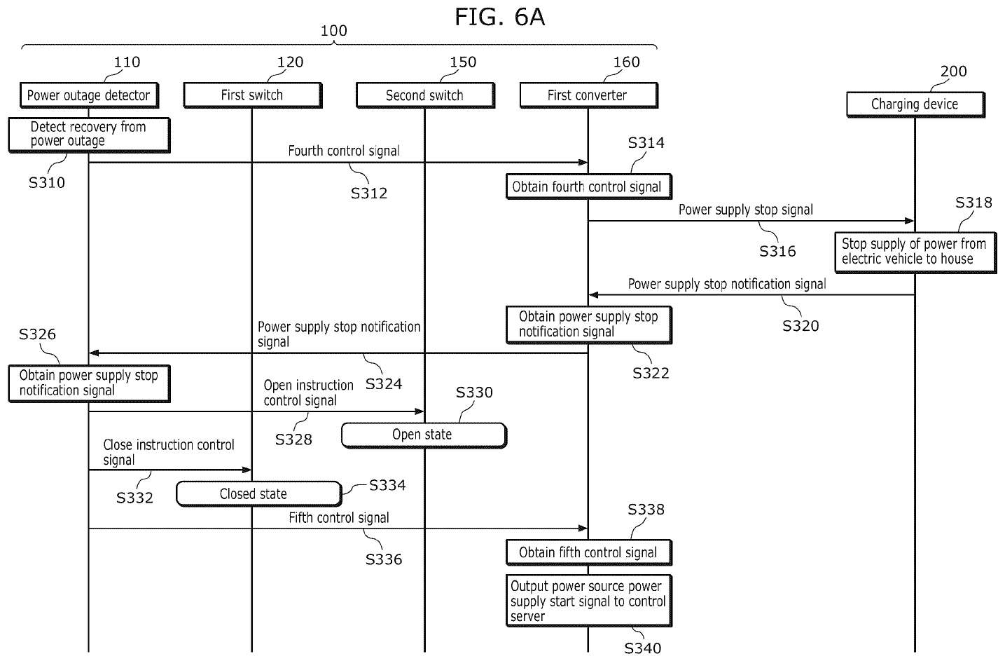

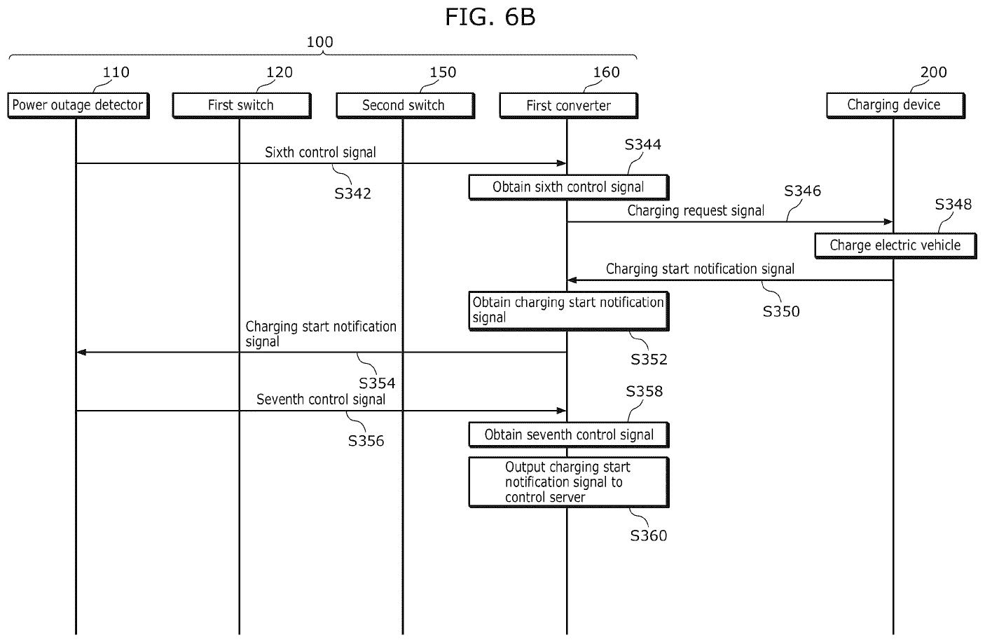

FIGS. 6A and 6B are sequence charts of Operation Example 4 performed by system 1 according to the present embodiment. The processing illustrated in FIG. 6B is performed after the processing illustrated in FIG. 6A is performed.

Prior to Operation Example 4 illustrated in FIG. 6A being performed, power is supplied from electric vehicle V to house H, first switch 120 and third switch 230 are in an open state, and second switch 150 and fourth switch 240 are in a closed state. In other words, first switch 120 and third switch 230 open the circuit, and second switch 150 and fourth switch 240 close the circuit.

First, power outage detector 110 detects a recovery from a power outage based on a voltage supplied from commercial power supply P (S310).

Controller 112 obtains the voltage value output from voltmeter 111, and determines that a power outage of commercial power supply P has been recovered from when the voltage value obtained is at least a predetermined value (threshold).

Then, when the recovery from the power outage is detected in step S310, controller 112 outputs a fourth control signal to first converter 160 (S312). First converter 160 obtains the fourth control signal output from controller 112 (S314).

When first converter 160 obtains the fourth control signal, first converter 160 outputs a power supply stop signal to second converter 220 of charging device 200 (S316). The power supply stop signal is a signal for requesting the supply of power from electric vehicle V to house H to be stopped. Note that first converter 160 multiplexes the power supply stop signal on power line PL1, and outputs that signals to second converter 220 by the first power line communication.

In this manner, in steps S312 to S316, controller 112 controls first converter 160 to output the power supply stop signal to second converter 220.

When second converter 220 obtains the power supply stop signal output by first converter 160, charging device 200 (calculator 250) stops the supply of power from electric vehicle V to house H in accordance with the power supply stop signal obtained (S318). Specifically, calculator 250 outputs a control signal instructing a shift to the open state to fourth switch 240, and fourth switch 240 obtains the control signal and shifts to the open state. Fourth switch 240 opens the circuit as a result.

Next, second converter 220 of charging device 200 outputs a power supply stop notification signal to first converter 160 (S320). The power supply stop notification signal is a signal for making a notification that the supply of power from electric vehicle V to house H has been stopped in step S318.

First converter 160 obtains the power supply stop notification signal output by second converter 220 (S322). Furthermore, first converter 160 outputs the power supply stop notification signal obtained to controller 112 of power outage detector 110 (S324).

When controller 112 obtains the power supply stop notification signal output by first converter 160 (S326), controller 112 outputs the following control signals to first switch 120, second switch 150, and first converter 160.

First, controller 112 outputs a control signal instructing second switch 150 to shift to the open state (an open instruction control signal) to second switch 150 (S328), and second switch 150 obtains the open instruction control signal and shifts to the open state (S330). Second switch 150 opens the circuit as a result.

Next, controller 112 outputs a control signal instructing first switch 120 to shift to the closed state (a close instruction control signal) to first switch 120 (S332), and first switch 120 obtains the close instruction control signal and enters the closed state (S334). First switch 120 closes the circuit as a result.

Next, controller 112 outputs a fifth control signal to first converter 160 (S336). First converter 160 obtains the fifth control signal output from controller 112 (S338).

When first converter 160 obtains the fifth control signal, first converter 160 outputs the power source power supply start signal, indicating that the supply of power from commercial power supply P has been started, to communicator 610 of control server 600 via gateway 500 (S340).

In this manner, in steps S336 to S340, controller 112 controls first converter 160 to output the power source power supply start signal to communicator 610.

Next, communicator 610 obtains the power source power supply start signal output, and the power source power supply start signal obtained is stored in storage 630. In step S340, first converter 160 may output the power source power supply start signal to wireless communicator 730 of mobile terminal 700. When wireless communicator 730 obtains the power source power supply start signal, calculator 740 controls display 720 to display an image indicating that the supply of power from commercial power supply P has been started. The image is stored in storage 750, for example. This enables the user to understand that the supply of power from commercial power supply P has been started.

Furthermore, controller 112 outputs a sixth control signal to first converter 160 (S342). First converter 160 obtains the sixth control signal output from controller 112 (S344).

When first converter 160 obtains the sixth control signal, first converter 160 outputs a charging request signal to second converter 220 of charging device 200 (S346). The charging request signal is a signal for requesting charging device 200 to charge electric vehicle V. Note that first converter 160 multiplexes the charging request signal on power line PL1, and outputs that signals to second converter 220 by the first power line communication.

In this manner, in steps S342 to S346, controller 112 controls first converter 160 to output the charging request signal to second converter 220.

When second converter 220 obtains the charging request signal output by first converter 160, charging device 200 charges electric vehicle V in accordance with the charging request signal obtained (S348). Specifically, calculator 250 outputs a control signal instructing a shift to the closed state to third switch 230, and third switch 230 obtains the control signal and shifts to the closed state. As a result, third switch 230 closes the circuit, and charging device 200 charges electric vehicle V.

Next, second converter 220 of charging device 200 outputs a charging start notification signal to first converter 160 (S350). The charging start notification signal is a signal for making a notification that the charging of electric vehicle V by charging device 200 has been started in step S344.

First converter 160 obtains the charging start notification signal output by second converter 220 (S352). Furthermore, first converter 160 outputs the charging start notification signal obtained to controller 112 of power outage detector 110 (S354).

Upon obtaining the charging start notification signal output by first converter 160, controller 112 outputs a seventh control signal to first converter 160 (S356). First converter 160 obtains the seventh control signal output from controller 112 (S358).

When first converter 160 obtains the seventh control signal, first converter 160 outputs the charging start notification signal to communicator 610 of control server 600 via gateway 500 (S360).

In this manner, in steps S356 to S360, controller 112 controls first converter 160 to output the charging start notification signal to communicator 610.

Next, communicator 610 obtains the charging start notification signal output, and the charging start notification signal obtained is stored in storage 630. In step S360, first converter 160 may output the charging start notification signal to wireless communicator 730 of mobile terminal 700. When wireless communicator 730 obtains the charging start notification signal, calculator 740 controls display 720 to display an image indicating that charging of electric vehicle V by charging device 200 has been started. The image is stored in storage 750, for example. This enables the user to understand that the charging of electric vehicle V by charging device 200 has been started. Effects, Etc.

Invention 1 is building-side panel 100 provided on an exterior of a building and to be connected to charging device 200 that charges electric vehicle V. Building-side panel 100 includes: power outage detector 110 that detects a power outage based on a voltage supplied by commercial power supply P; a main breaker (first main breaker 130) connected to commercial power supply P via power outage detector 110; and a switch (first switch 120) provided between power outage detector 110 and charging device 200. The switch (first switch 120) is opened when the power outage is detected.

Through this, during a power outage, first switch 120 is in an open state, which suppresses reverse power flow to commercial power supply P, even when power is supplied from electric vehicle V to house H. In other words, building-side panel 100 which makes reverse power flow unlikely to occur is realized.

Invention 2 is building-side panel 100 according to Invention 1, wherein the switch (first switch 120) is provided between power outage detector 110 and the main breaker (first main breaker 130).

Through this, the distance between power outage detector 110 and first switch 120 can be shortened, and a signal line for outputting a control signal from controller 112 of power outage detector 110 to first switch 120 can be shortened. This makes it possible to reduce the risk of the signal line being cut when an earthquake or the like occurs, i.e., to increase the probability that controller 112 will control first switch 120.

Invention 3 is building-side panel 100 according to Invention 1 or 2, further including an other switch (second switch 150) provided between charging device 200 and residential distribution panel 300 that distributes power to a plurality of loads provided in house H, wherein the other switch (second switch 150) is closed when the power outage is detected.

Through this, in the event of a power outage in commercial power supply P, power can be supplied from electric vehicle V to house H.

Invention 4 is building-side panel 100 according to Invention 3, wherein when power outage detector 110 detects a recovery from the power outage, the switch (first switch 120) is closed and the other switch (second switch 150) is opened.

Through this, when commercial power supply P recovers from a power outage, the supply of power from electric vehicle V to house H is stopped, and the supply of power from commercial power supply P is started.

Invention 5 is system 1 including building-side panel 100 according to any one of Inventions 1 to 4 and charging device 200. As described above, building-side panel 100 can suppress reverse power flow to commercial power supply P even when power is supplied from electric vehicle V to house H. Similarly, system 1 including building-side panel 100 can suppress reverse power flow to commercial power supply P even when power is supplied from electric vehicle V to house H.

The following techniques will also be described.

Technique 1 is charging device 200 that is connected to an external device (e.g., building-side panel 100) by power line PL1 and that charges electric vehicle V, charging device 200 including: communicator 210 that obtains a connection notification signal from electric vehicle V by wired communication, the connection notification signal indicating that electric vehicle V and charging device 200 are connected; and a converter (second converter 220) that converts the connection notification signal obtained into a signal format compliant with a communication standard of first power line communication performed over power line PL1 to obtain a converted connection notification signal, and outputs the converted connection notification signal to the external device by the first power line communication, wherein the wired communication is communication different from the first power line communication.

Power line PL1 is a power line used to charge electric vehicle V, and supplies a voltage of at least 100 V.

Through this, the wired communication is communication different from the first power line communication, and thus even if communicator 430 outputs a connection notification signal to communicator 210 by the wired communication, i.e., even if that wired communication is performed, a high voltage such as 100 V or 200 V is not applied. Accordingly, electromagnetic noise is less likely to be produced by the wired communication, and problems such as difficulty charging electric vehicle V are less likely to arise.

Charging device 200 capable of charging electric vehicle V more reliably is achieved as a result.

Furthermore, in the present embodiment, the connection notification signal can be converted into a signal compliant with the communication standard of the first power line communication by the converter (second converter 220), and thus the first power line communication can be used as the communication between charging device 200 and the external device. It is therefore not necessary to newly provide a wired LAN or the like for communication between charging device 200 and the external device, and charging device 200 having high workability can be achieved.

Technique 2 is charging device 200 according to Technique 1, wherein communicator 210 uses second power line communication as the wired communication, the second power line communication using a voltage lower than a voltage supplied by power line PL1.

Through this, the second power line communication, which has a voltage of 12 V, for example, can be used as the wired communication. In this case too, even if the wired communication is performed, a high voltage, such as 100 V or 200 V, is not applied. Accordingly, electromagnetic noise is less likely to be produced by the wired communication, and problems such as difficulty charging electric vehicle V are less likely to arise.

Charging device 200 capable of charging electric vehicle V more reliably is achieved as a result.

Technique 3 is charging device 200 according to Technique 1 or 2, wherein the converter (second converter 220) outputs the converted connection notification signal when electric vehicle V is not being charged.

Through this, second converter 220 can output the post-conversion connection notification signal when electric vehicle V is not charging.

Technique 4 is charging device 200 according to any one of Techniques 1 to 3, wherein communicator 210 obtains a vehicle ID signal from electric vehicle V by the wired communication, the vehicle ID signal indicating a vehicle ID identifying electric vehicle V, and the converter (second converter 220) converts the vehicle ID signal obtained into a signal format compliant with the communication standard of the first power line communication to obtain a converted vehicle ID signal, and outputs the converted vehicle ID signal to the external device by the first power line communication.

Through this, second converter 220 can output the connection notification signal and the vehicle ID signal that have been converted to the signal format compliant with the communication standard of the first power line communication.

Technique 5 is system 1 including: charging device 200 according to any one of Techniques 1 to 4; and an external device.

As described above, charging device 200 can more reliably charge electric vehicle V. Similarly, system 1 including charging device 200 can more reliably charge electric vehicle V.

Technique 6 is system 1 including: power outage detector 110 that detects a power outage based on a voltage supplied from commercial power supply P; charging device 200 that is connected to commercial power supply P via power outage detector 110 and that charges electric vehicle V; residential distribution panel 300 that is connected to commercial power supply P via power outage detector 110 and that supplies power to a plurality of loads provided in house H; and second switch 150 provided between charging device 200 and residential distribution panel 300, wherein when a power outage is detected, second switch 150 is closed, and AC voltage supplied from electric vehicle V is supplied to residential distribution panel 300.

Through this, the voltage supplied from electric vehicle V to each of the plurality of loads (the plurality of household appliances) during a power outage is AC voltage, and the household appliances in house H therefore need only handle AC voltage. In general, the voltage supplied from commercial power supply P is AC voltage, and the user therefore need not prepare special household appliances for the event of a power outage. Accordingly, system 1 according to the present embodiment is a system which is highly convenient for users.

Technique 7 is system 1 according to Technique 6, wherein residential distribution panel 300 supplies a supplied AC voltage to a predetermined load among a plurality of loads.

Through this, a load that requires continuous operation, such as a refrigerator or an air conditioner, or a load that a user wishes to operate, can be preferentially operated during a power outage.

Technique 8 is system 1 according to Technique 6 or 7, further including first switch 120 provided between power outage detector 110 and charging device 200, wherein when a power outage is detected, first switch 120 is opened.

Through this, during a power outage, first switch 120 is in an open state, which suppresses reverse power flow to commercial power supply P, even when power is supplied from electric vehicle V to house H. In other words, building-side panel 100 which makes reverse power flow unlikely to occur is realized.

Technique 9 is system 1 according to Technique 8, wherein when power outage detector 110 detects a recovery from a power outage, second switch 150 is opened and first switch 120 is closed.

Through this, when commercial power supply P recovers from a power outage, the supply of power from electric vehicle V to house H is stopped, and the supply of power from commercial power supply P is started.

Technique 10 is a method performed by system 1, system 1 including: power outage detector 110; charging device 200 that is connected to commercial power supply P via power outage detector 110 and that charges electric vehicle V; residential distribution panel 300 that is connected to commercial power supply P via power outage detector 110 and that supplies power to a plurality of loads provided in house H; and second switch 150 provided between charging device 200 and residential distribution panel 300, and the method including: a step of power outage detector 110 detecting a power outage based on a voltage supplied from commercial power supply P; and a step of, when a power outage is detected, closing second switch 150, and supplying, to residential distribution panel 300, AC voltage supplied from electric vehicle V.

Through this, the voltage supplied from electric vehicle V to each of the plurality of loads (the plurality of household appliances) during a power outage is AC voltage, and the household appliances in house H therefore need only handle AC voltage. In general, the voltage supplied from commercial power supply P is AC voltage, and the user therefore need not prepare special household appliances for the event of a power outage. Accordingly, the method according to the present embodiment is a method that is highly convenient for users.

### OTHER EMBODIMENTS

Although an embodiment has been described thus far, the present disclosure is not limited to the foregoing embodiment.

In steps S28 and S30 of Operation Example 1, wired communicator 520 outputs the connection notification signal and control server 600 obtains the connection notification signal. However, the configuration is not limited thereto. For example, in step S28, wired communicator 520 may output the vehicle ID signal and the device ID signal but not the connection notification signal, and in step S30, control server 600 may obtain the vehicle ID signal and the device ID signal but not the connection notification signal.

Additionally, processing executed by a specific processing unit in the foregoing embodiment may be executed by a different processing unit. In the foregoing embodiment, when the two devices communicate, a relay device (not shown) may be provided between the two devices.

The orders of the processes illustrated in the sequence charts in the foregoing embodiment are examples. The order of multiple processes may be changed, and multiple processes may be executed in parallel.

Additionally, in the foregoing embodiment, the constituent elements may be implemented by executing software programs corresponding to those constituent elements. Each constituent element may be realized by a program executor such as a CPU or a processor reading out and executing a software program recorded into a recording medium such as a hard disk or semiconductor memory.

Each constituent element may be implemented by hardware. For example, each constituent element may be circuitry (or integrated circuitry). This circuitry may constitute a single overall circuit, or may be separate circuits. The circuitry may be generic circuitry, or may be dedicated circuitry.

The general or specific aspects of the present disclosure may be implemented by a system, a device, a method, an integrated circuit, a computer program, or a computer-readable recording medium such as a CD-ROM. These forms may also be implemented by any desired combination of systems, devices, methods, integrated circuits, computer programs, and recording media.

For example, the present disclosure may be implemented as a method executed by a computer, or as a program for causing a computer to execute such a method. Additionally, the present disclosure may be implemented as a non-transitory computer-readable recording medium in which such a program is recorded.

Note that embodiments resulting from variations of the above embodiments arrived at by those skilled in the art, as well as embodiments resulting from optional combinations of elements and functions in the above embodiments are included within the present disclosure as long as the embodiments do not depart from the scope of the present disclosure.

1. A building-side panel provided on an exterior of a building and to be connected to a charging device that charges an electric vehicle, the building-side panel comprising:
a power outage detector that detects a power outage based on a voltage supplied by a commercial power supply;
a main breaker connected to the commercial power supply via the power outage detector; and
a switch provided between the power outage detector and the charging device,
wherein the switch is opened when the power outage is detected.

2. The building-side panel according to claim 1,
wherein the switch is provided between the power outage detector and the main breaker.

3. The building-side panel according to claim 1, further comprising:
an other switch provided between the charging device and a residential distribution panel that distributes power to a plurality of loads provided in the building,
wherein the other switch is closed when the power outage is detected.

4. The building-side panel according to claim 3,
wherein when the power outage detector detects a recovery from the power outage, the switch is closed and the other switch is opened.

5. A system comprising:
the building-side panel according to claim 1; and
the charging device.
